(19) United States
(12) Patent Application Publication
(10) Pub. No.: US 2014/0183803 A1
(43) Pub. Date: Jul. 3, 2014

(54) MOUNTING BUSH

(71) Applicants: HYUNDAI MOTOR COMPANY, Seoul (KR); KIA MOTORS CORPORATION, Seoul (KR)

(72) Inventors: Tae Sun Ha, Yongin (KR); Yong Jin Cho, Hwaseong (KR); Young Gun Cho, Seoul (KR); Gook Young Choi, Daegu (KR); Dong Suk Kang, Daegu (KR)

(73) Assignees: KIA MOTORS CORPORATION, Seoul (KR); HYUNDAI MOTOR COMPANY, Seoul (KR)

(21) Appl. No.: 13/873,672

(22) Filed: Apr. 30, 2013

(30) Foreign Application Priority Data
Dec. 27, 2012 (KR) 10-2012-0154609

(51) Int. Cl. F16C 11/06

(52) U.S. Cl. CPC F16C 11/0666
USPC 267/292

(57) ABSTRACT

A mounting bush is provided including: an outer pipe inserted into a mounting member of a vehicle and having protrusions on an inner surface of the outer pipe; an inner pipe that is concentric with the outer pipe, inserted into the outer pipe at a location spaced inward from the outer pipe by a predetermined distance, and having recesses at locations corresponding to the protrusions; and a filling material filled between the outer pipe and the inner pipe.

### CROSS-REFERENCE TO RELATED APPLICATION

This application claims under 35 U.S.C. §119(a) the benefit of Korean Patent Application No. 10-2012-0154609 filed Dec. 27, 2012, the entire contents of which are incorporated herein by reference.

### BACKGROUND

(a) Technical Field

The present invention relates to a mounting bush mounted to a cross member of a vehicle.

(b) Description of the Related Art

In general, a cross member is installed at a portion of a suspension of a vehicle at which a load is concentrated, where a front cross member is installed at a front side thereof and a rear cross member is installed at a rear side thereof. The cross member bears a lateral load transferred to a vehicle body while supporting many components of the suspension, where a plurality of cross members extending in a widthwise direction of the vehicle are welded while overlapping each other, and a mounting bush coupling each cross member to the vehicle body penetrates a through hole formed in the cross member or is welded to an end of the cross member.

In Korean Unexamined Patent Publication No. 10-1996-070284A, a resilient curved portion which is convex outward is formed at a central portion of a rubber bush to resiliently bear a load applied to a trail link, thereby more effectively coping with deformation characteristics of the rubber bush. However, since the curved portion is not completely attached to the trail link due to the curved shape, there is an inconvenience of additionally inserting a spacer.

FIG. 1 is a view showing a mounting bush according to the related art, and FIG. 2 is a sectional view taken along the line A-A of FIG. 1. FIG. 1 shows that a filling material is filled between an inner pipe 10 and an outer pipe 30 which are concentric with each other. It can be seen from FIG. 2, which is a sectional view taken along the line A-A of FIG. 1, that an outer side of the inner pipe 10 and an inner side of the outer pipe 30 are simply linear without having a particular shape.

However, the above-described related art may not satisfy requirements of ride feeling (upward and downward soft vibrations), handling (leftward and rightward hard vibrations), and impact (forward and rearward soft vibrations) required by a rear cross member bush, in which case manipulation stability is reduced and a NVH (noise, vibration, and harshness) problem is caused due to poor handling.

Further, loads supported by a front cross member bush and the rear cross member bush are different, and thus the front cross member and the rear cross member must have their own characteristics, respectively, but these characteristics are not satisfied by using the same mounting bush.

Thus, there is a need for a mounting bush which can improve both an NVH problem and handling without using a separate component, and can satisfy characteristics required by a front cross member and a rear cross member, respectively, while providing satisfactory travel performance and ride feeling.

The items described as the background art is provided just to help understanding of the background of the present invention, and shall not be construed to admit that they correspond to the technologies already known to those skilled in the art to which the present invention pertains.

### SUMMARY OF THE DISCLOSURE

The present invention has been made in an effort to solve the above-described problems associated with the related art. An object of the present invention is to provide a mounting bush which can improve both an NVH problem and handling without using a separate component and can satisfy characteristics required by a front cross member and a rear cross member, respectively, while providing satisfactory travel performance and ride feeling.

In one aspect, the present invention provides a mounting bush including: an outer pipe inserted into a mounting member of a vehicle and having protrusions on an inner surface of the outer pipe; an inner pipe that is concentric with the outer pipe, inserted into the outer pipe at a location spaced inward from the outer pipe by a predetermined distance, and having recesses at locations corresponding to the protrusions; and a filling material filled between the outer pipe and the inner pipe.

Two parallel linear sections and curved sections that connect ends of the two parallel linear sections may be formed on the inner surface of the outer pipe.

Two parallel linear sections and curved sections that connect ends of the two parallel linear sections may be formed on the inner surface of the outer pipe, and protrusions protruding inward are formed in the curved sections.

The protrusions may vertically protrude from the inner surface of the outer pipe and may have an inwardly convex arc shape.

The arc-shaped surfaces of the protrusions may be arced from an inner side toward an outer side, and upper surfaces of the protrusions may be recessed by a predetermined depth.

Tapers having a predetermined inclination may be formed at edges of the protrusions, respectively.

An outer surface of the outer pipe may have a cylindrical shape formed vertically about an axis thereof.

A cylindrical through-hole may be formed vertically on an inner side of the inner pipe about an axis thereof.

Two parallel linear sections and two curved sections that connect ends of the two parallel linear sections may be formed vertically about an axis of the inner pipe on an outer surface thereof.

Two parallel linear sections and two curved sections that connect ends of the two parallel linear sections may be formed on an outer surface of the inner pipe, the inner pipe may extend vertically about the axis thereof, and opposite tip points of the recesses of the inner pipe correspond to edges where the linear sections and the curved sections meet each other such that the recesses of the inner pipe each have an arc shape which is inwardly convex.

Two parallel linear sections and curved sections that connect ends of the two parallel linear sections may be formed on an inner surface of the outer pipe, an additional two parallel linear sections and curved sections that connect ends of the two linear sections may be formed on an outer surface of the inner pipe, and the curvatures of the curved sections of the outer pipe and the inner pipe are the same such that the two curved sections on each of the outer pipe and the inner pipe are spaced apart from each other by a predetermined distance to be parallel to each other.

The filling material may be filled between the protrusions of the outer pipe and the recesses of the inner pipes and may have the same thickness from a top to a bottom thereof. The filling material may be a rubber.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

### BRIEF DESCRIPTION OF THE DRAWINGS

The above and other features of the present invention will now be described in detail with reference to certain exemplary embodiments thereof illustrated in the accompanying drawings which are given herein below by way of illustration only, and thus are not limitative of the present invention, and wherein:

FIG. 1 (RELATED ART) is a view showing a mounting bush according to the related art;

FIG. 2 (RELATED ART) is a sectional view taken along the line A-A of FIG. 1;

FIG. 3 is a view showing a mounting bush according to an embodiment of the present invention;

FIG. 4 is a view showing an inner pipe according to the embodiment of the present invention;

FIG. 5 is a view showing an outer pipe according to the embodiment of the present invention;

FIG. 6 is a sectional view taken along the line B-B of FIG. 3;

FIG. 7 is a view showing that the mounting bush is mounted to a vehicle; and

FIG. 8 is an enlarged view of part C of FIG. 7.

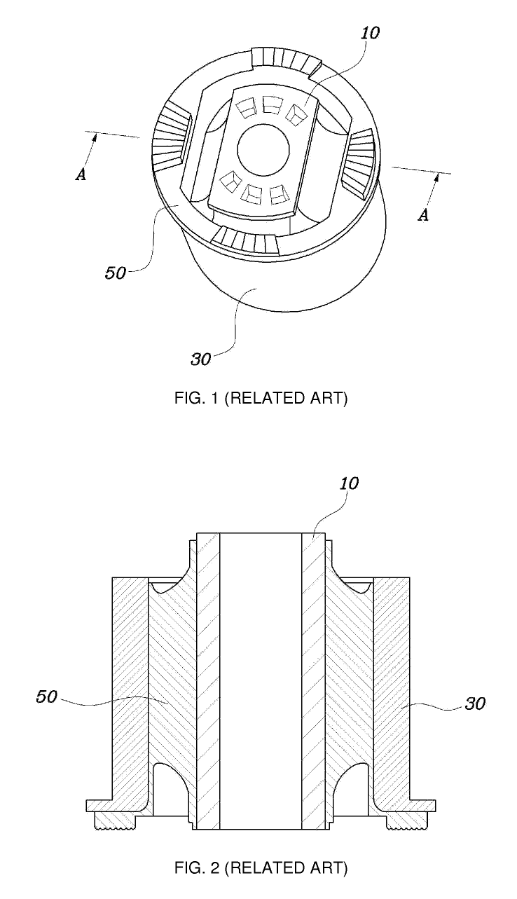

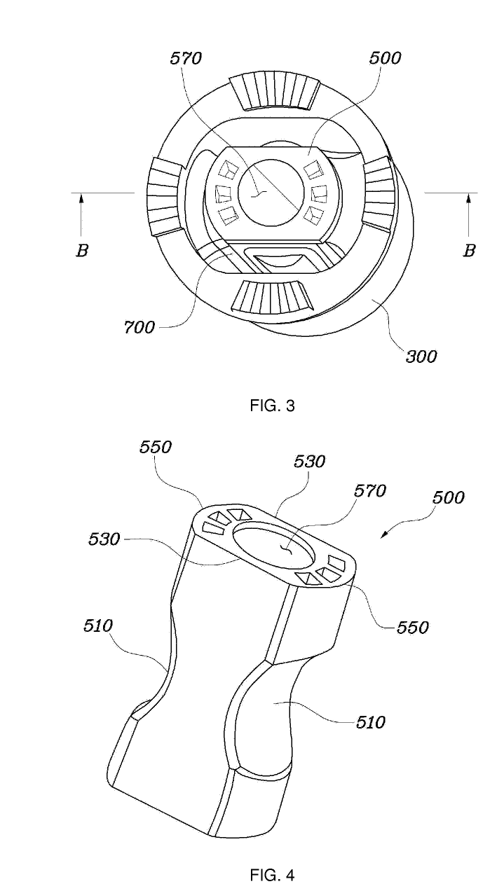

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, a mounting bush according to an exemplary embodiment of the present invention will be described with reference to the accompanying drawings.

FIG. 3 is a view showing a mounting bush according to an embodiment of the present invention. The mounting bush includes: an outer pipe 300 inserted into a mounting member 100 of a vehicle and having protrusions 310 on an inner surface of the outer pipe 300; an inner pipe 500 being concentric with the outer pipe 300, inserted into the outer pipe 300 at a location spaced inward from the outer pipe 300 by a predetermined distance, and having recesses 510 at locations corresponding to the protrusions 310; and a filling material 700 filled between the outer pipe 300 and the inner pipe 500. The term “mounting member” has a more general meaning than “cross member,” but these terms are used interchangeably herein, so that a mounting member refers to a cross member.

FIG. 4 is a view showing the inner pipe 500 according to the embodiment of the present invention. A cylindrical through-hole 570 is formed vertically about an axis of the inner pipe 500 inside the inner pipe 500, and two parallel linear sections 530 and two curved sections 550 that connect ends of the two linear sections 530, respectively, are formed vertically about the axis of the inner pipe 500 on an outer surface thereof. Here, a recess 510 of the inner pipe 500 is configured such that opposite tip points of the recesses 510 correspond to edges where the linear sections 530 and the curved sections 550 meet each other such that it has an arc shape which is inwardly convex.

In particular, the inner pipe 500 is formed vertically about the axis thereof such that it has a shape in which edge portions of narrow surfaces of a rectangular column are curved. The inwardly recessed recesses 510 are formed at central portions of the curved surfaces, respectively, and the lengthwise corners are tapered at a predetermined curvature.

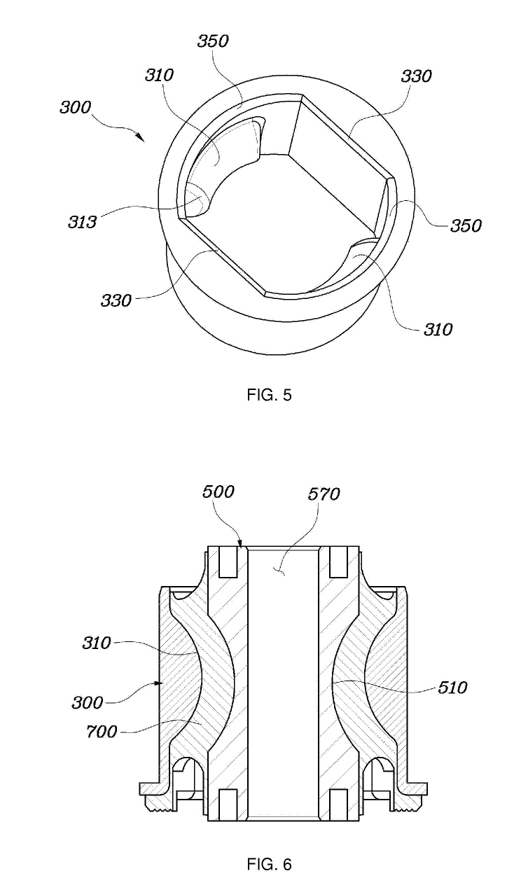

FIG. 5 is a view showing the outer pipe 300 according to the embodiment of the present invention. An outer surface of the outer pipe 300 has a cylindrical shape formed vertically about an axis thereof, two parallel linear sections 330 and curved sections 350 that connect ends of the two parallel linear sections 330 are formed on an inner surface of the outer pipe 300, and protrusions 310 protruding inward are formed in the curved sections 350, respectively.

The protrusions 310 have an inverse bulge shape protruding vertically on an inner surfaces of the outer pipe 300 and corresponding to an arc shape which is inwardly convex such that arc-shaped surfaces of the protrusions 310 have arc shapes which are arced from an inside toward an outer side thereof, upper surfaces of the protrusions 310 are recessed at a predetermined depth, and tapers 313 having a predetermined inclination are formed at edges of the protrusions 310.

In particular, the outer pipe 300 has a cylindrical outer surface and has the inwardly convex protrusions 310 on an inner surface thereof. For visualization purposes, if the protrusions are formed in a flat plate and then are cut to have a predetermined curvature, it appears as if the protruding portions protrude inwardly. Further, the curvatures of the curved sections of the outer pipe 300 and the inner pipe 500 are the same such that the two curved sections are spaced apart each other from a predetermined distance to be parallel to each other.

It can be seen from FIG. 6, which is a sectional view taken along the line B-B of FIG. 3, that the inner pipe 500 having a through-hole 570 about the axis thereof is provided, the filling material 700 is filled outside the inner pipe, and the outer pipe having the protrusions 310 is formed outside the filling material 700.

The protrusions 310 and the recesses 510 are formed at locations corresponding to each other and the filling material 700 is filled therebetween, such that the curved structures of the protrusions 310 and the recesses 510 function as a stopper in the case of a large displacement due to upward and downward vibrations, thereby reducing NVH without using an additional component, and providing a satisfactory ride feeling.

The inner pipe 500 and the outer pipe 300 further can be attached and gripped to each other to satisfy travel performance requirements such as improving handling due to their advantageous lateral strength, and holes formed at the top and bottom of the filling material 700 can become deeper and thus a forward and rearward impact performance of the vehicle can be improved by increasing an empty space.

Further, since desired performance characteristics can be obtained through changing radii of curvature of the protrusions 310 and the recesses 510, a design can be made according to the characteristics required by the front cross member and the rear cross member, respectively.

The filling material 700 is filled between the protrusions 310 of the outer pipe 300 and the recesses 510 of the inner pipe 500 and is curing-bonded to the outer pipe 300 and the inner pipe 500, respectively. In particular, the filling material is filled to have the same thickness from a top to a bottom thereof. The filling material 700 is formed of an ultra-resilient material such as a rubber to mitigate external vibrations, noise, and impacts.

The filling material 700 preferably has grooves along upper and lower circumferences of the inner pipe 500 so that plates are coupled to upper and lower sides of the inner pipe when it is mounted to the cross member. When it is mounted to the cross member, an upper stopper is coupled between the plate and the filling material 700 at an upper side of the mounting bush to insulate against additional vibration.

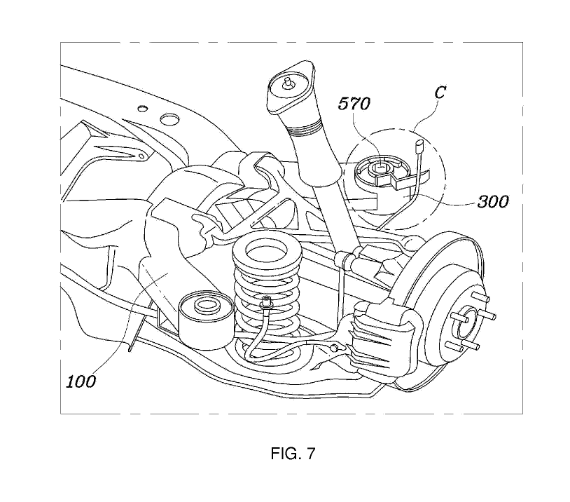

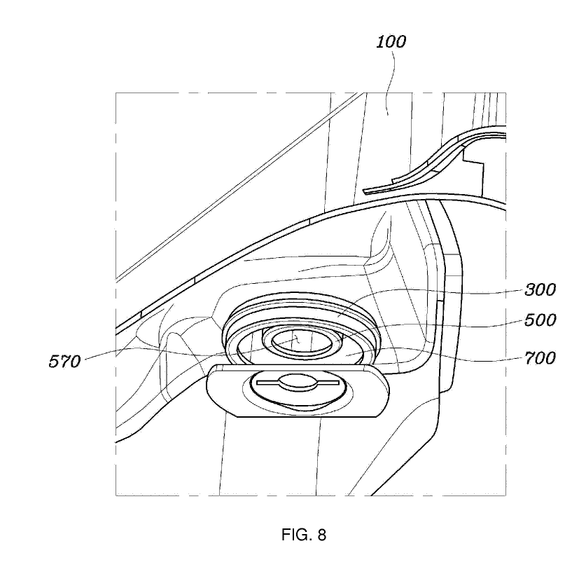

FIG. 7 is a view showing the mounting bush mounted to the vehicle, and FIG. 8 is an enlarged view of part C of FIG. 7, in which the mounting bush is mounted to an end of the mounting member 100 of the vehicle.

As compared to a mounting bush of the related art, the mounting bush of the present invention has improved material characteristics including low dynamic ratio and secure durability, the shape of the pipe is optimized by improving the shape for reinforcing performance, and the shape of the bush is optimized by setting overlapping and gap sizes of the stopper. Thus, ride feeling and handling are improved, and a degree of freedom is increased by eliminating NVH problems.

When the cross member is mounted, plates are coupled to upper and lower sides of the cross member, and when the mounting bush is assembled in the cross member, the mounting bush is prevented from being deflected. In particular, an upper stopper is coupled between the plate and the filling material at an upper side of the cross member to further improve insulating performance.

According to the mounting bush having the above structure, the curved structure formed at locations where the recesses of the inner pipe and the protrusions of the outer pipe correspond to each other functions as a stopper when it comes to a large displacement due to upward and downward vibrations, thus further reducing NVH through a simple change of design. The inner pipe and the outer pipe are further attached to each other to grip each other leftward and rightward, improving lateral strength, handling, and overall travel performance. Further, since holes formed at upper and lower sides of the filling material 700 can become deeper, forward and rearward impact performance of the vehicle can be improved by increasing an empty space. Additionally, since desirable performance characteristics can be obtained by changing radii of curvature of the protrusions and the recesses, a design can be made according to the characteristics required by the front and rear cross members, respectively.

The filling material preferably has grooves along upper and lower circumferences of the inner pipe such that when the cross member is mounted, plates are coupled to upper and lower sides of the cross member, and when the mounting bush is assembled in the cross member, the mounting bush is prevented from being deflected. In particular, an upper stopper is coupled between the plate and the filling material at an upper side of the cross member to further improve insulating performance. Further, the filling material is formed of an ultra-resilient material such as a rubber to mitigate external vibrations, noise, and impacts.

According to the mounting bush according to the embodiment of the present invention, the characteristics of the mounting bush are reinforced and durability is secured by improving material characteristics of the mounting bush, the shape of the pipe is optimized by improving the shape for reinforcing performance, and the shape of the bush is optimized by setting overlapping and gap sizes of the stopper. Thus, ride feeling and handling are improved, and a degree of freedom is increased.

While the present invention has been illustrated and described with reference to specific embodiments, it is apparent to those skilled in the art to which the present invention pertains that the present invention may be variously improved and changed without departing from the scope of the present invention.

What is claimed is:

1. A mounting bush comprising:
an outer pipe inserted into a mounting member of a vehicle and having protrusions on an inner surface of the outer pipe;
an inner pipe that is concentric with the outer pipe, the inner pipe being inserted into the outer pipe at a location spaced inward from the outer pipe by a predetermined distance, and having recesses at locations corresponding to the protrusions; and
a filling material filled between the outer pipe and the inner pipe.

2. The mounting bush according to claim 1, wherein two parallel linear sections and curved sections that connect ends of the two parallel linear sections are formed on the inner surface of the outer pipe.

3. The mounting bush according to claim 1, wherein two parallel linear sections and curved sections that connect ends of the two parallel linear sections are formed on the inner surface of the outer pipe, and protrusions protruding inward are formed in the curved sections.

4. The mounting bush according to claim 3, wherein the protrusions vertically protrude from the inner surface of the outer pipe and have an inwardly convex arc shape.

5. The mounting bush according to claim 4, wherein the arc-shaped surfaces of the protrusions are arced from an inner side toward an outer side thereof, and upper surfaces of the protrusions are recessed by a predetermined depth.

6. The mounting bush according to claim 5, wherein tapers having a predetermined inclination are formed at edges of the protrusions, respectively.

7. The mounting bush according to claim 1, wherein an outer surface of the outer pipe has a cylindrical shape formed vertically about an axis thereof.

8. The mounting bush according to claim 1, wherein a cylindrical through-hole is formed vertically on an inner side of the inner pipe about an axis thereof.

9. The mounting bush according to claim 1, wherein two parallel linear sections and two curved sections that connect ends of the two parallel linear sections are formed vertically about an axis of the inner pipe on an outer surface thereof.

10. The mounting bush according to claim 1, wherein two parallel linear sections and two curved sections that connect ends of the two parallel linear sections are formed on an outer surface of the inner pipe, the inner pipe extends vertically about an axis thereof, and opposite tip points of the recesses of the inner pipe correspond to edges where the linear sections and the curved sections meet each other such that the recesses of the inner pipe each have an arc shape which is inwardly convex.

11. The mounting bush according to claim 1, wherein two parallel linear sections and curved sections that connect ends of the two linear sections are formed on the inner surface of the outer pipe, an additional two parallel linear sections and curved sections that connect ends of the two parallel linear sections are formed on an outer surface of the inner pipe, and the curvatures of the curved sections of the outer pipe and the inner pipe are the same such that the two curved sections on each of the outer pipe and the inner pipe are spaced apart from each other by a predetermined distance to be parallel to each other.

12. The mounting bush according to claim 1, wherein the filling material is filled between the protrusions of the outer pipe and the recesses of the inner pipes, and has the same thickness from a top to a bottom thereof.

13. The mounting bush according to claim 1, wherein the filling material is a rubber.
